(19) United States
(12) Patent Application Publication
(10) Pub. No.: US 2006/0044828 A1
(43) Pub. Date: Mar. 2, 2006

(54) Display device, driving device of display device, and driving device of light source for display device

(76) Inventors: Jae-Kwang Kim, Seoul (KR); Sang-Hee Lee, Gyeonggi-do (KR)

Correspondence Address: PATENT LAW GROUP LLP, 2635 NORTH FIRST STREET, SUITE 223, SAN JOSE, CA, 95134, US

(21) Appl. No.: 11/218,067

(22) Filed: Sep. 1, 2005

(30) Foreign Application Priority Data
Sep. 2, 2004 (KR) 10-2004-0069868
Sep. 24, 2004 (KR) 10-2004-0077496

(51) Int. Cl. F21V 7/04

(52) U.S. Cl. 362/613; 362/612; 362/621

(57) ABSTRACT

A display device is provided. The display device includes a main display panel, a sub-display panel, and a plurality of lamps simultaneously supplying light to the first and second display panels; an openness sensing unit in which an output signal is defined based on a degree of openness of the display device; and a lamp controlling unit selecting one of the display panels based on the output signal from the openness sensing unit and defining the number of lamps to be turned on based on the selected display panel, and supplying the light to the main and sub-display panels by lighting the defined number of lamps. In one embodiment, the display device is a display device for a mobile phone, and the lamps are light emitting diodes. Accordingly, the number of lamps to be turned on is varied based on the selected display panel, and consumption power therefore decreases.

### BACKGROUND OF THE INVENTION

(a) Field of the Invention

The present invention relates to a display device, a driving device of the display device, and a driving device of a light source for the display device.

(b) Description of Related Art

Plasma display panels (PDPs) are devices which display characters or images using plasma generated by gas-discharge, and organic light emitting displays (OLEDs) are devices which display characters or images using electroluminescence. Liquid crystal displays (LCDs) are devices which display desired images by applying an electric field to a liquid crystal layer between two panels and regulating the strength of the electric field to adjust the transmittance of light passing through the liquid crystal layer.

A display having display panels separately disposed both internally and externally and which are mainly used for mobile phones, called “dual display devices” hereinafter, is being developed as a middle/small sized display.

The dual display device includes a main display panel disposed internally, a sub-display device disposed externally, a printed circuit board (PCB) for receiving signals from an external device and having a plurality of circuit components mounted thereon, a flexible printed circuit (FPC) board having a plurality of signal lines for transmitting the signals and being connected to the PCB to apply the signals from the sub-display panel to the main display panel, and an integrated chip controlling them.

The integrated chip generates control signals and driving signals for controlling the main display panel and the sub-display panel, and is mainly mounted on the main display panel in a COG (chip on glass) configuration.

Since products using the dual display device are usually portable, the products are supplied with supply voltages through a portable power supply for charging to a predetermined voltage. As various functions and services are supplied thereto and an amount of data being processed increases, consumption power increases, and thereby usage time of the charged voltage is gradually shortened. However, with the desired miniaturization both in volume and weight of the products, it is difficult to increase capacity of the power supply.

### SUMMARY OF THE INVENTION

A driving device of a light source for a display device is provided, the light source including a plurality of lamps connected in parallel to each other and each lamp having a first terminal and a second terminal, which includes: a lamp state sensing unit sensing driving voltages applied to the respective lamps, comparing the sensed driving voltages to a reference voltage, and outputting a lamp state sensing signal having information informing of an over-current state for at least one lamp; and an inverter turning the lamps on or off by applying an AC voltage thereto and controlling the AC voltage based on the lamp state sensing signal, wherein the reference voltage is varied depending on the magnitude of the driving voltages applied to the respective lamps.

A display device is provided, which includes: at least two display panels; a plurality of lamps emitting light to the display panels; and a lamp controlling unit for selecting a predetermined number of the lamps based on a panel selection signal applied externally, and selecting one of the display panels and supplying the light to the display panels by lighting the selected lamps.

The display panels may include a first display panel and a second display panel, and the first display panel is larger than the second display panel.

The selected lamps face an edge of the second display panel.

The number of lamps selected when the selected display panel is the second display panel may be less than the number of lamps selected when the selected display panel is the first display panel.

The display device may be a liquid crystal display.

The lamps may be light emitting diodes (LEDs).

A display device is provided, which includes: a first printed circuit board (PCB) including a plurality of lamps, a first lead connected to the lamps and a plurality of other leads connected to the lamps; a flexible printed circuit (FPC) board including a first signal line connected to the first lead and a plurality of signal lines connected to second leads, respectively; a second PCB including a third lead connected to the first signal line and a plurality of fourth leads connected to second signal lines; a lamp controlling unit applying a first voltage to a third lead, applying a second voltage to the fourth leads, and controlling the application of the second voltage based on an external panel selection signal; and first and second display panels simultaneously supplied with light from the lamps, wherein the lamp controlling unit is mounted on the second PCB and the lamps supply the light to the first and second display panels by lighting the lamps based on a difference between the first voltage and the second voltage.

The first voltage may be larger than the second voltage.

The lamps may be light emitting diodes (LEDs).

The first voltage may be commonly transmitted to one terminal of each of the LEDs and the second voltage is separately transmitted to the other terminals of the LEDs, and the lamp controlling unit may control the application of the second voltage applied to the respective other terminals of the LEDs based on the panel selection signal.

A method of driving a display device including at least two display panels and a plurality of lamps supplying light to the display panels is provided, the method including: reading an external panel selection signal; selecting one of the display panels based on the panel selection signal; selecting a predetermined number of lamps based on the selected panel; and supplying light to the display panels by lighting the selected lamps.

The display panels may include a first display panel and a second display panel, and the first display panel is larger than the second display panel.

A display device including a first display panel, a second display panel, and a plurality of lamps simultaneously supplying light to the first and second display panel is provided, the device including: an openness sensing unit, in which an output signal is defined based on the degree of openness of the display device; a lamp controlling unit selecting one of the display panels based on the output signal from the openness sensing unit, defining the number of lamps to be turned on based on the selected display panel, and supplying the light to the first and second display panels by lighting the defined number of lamps.

The first display panel may be larger than the second display panel, and the number of lamps selected when the selected display panel is the second display panel may be less than the number of lamps selected when the selected display panel is the first display panel.

The display device may be a display device for a mobile phone.

The lamps may be light emitting diodes.

A display device is provided, which includes: at least two display panels; a plurality of lamps supplying light to the display panels; and a lamp controlling unit varying a signal applied to the lamps based on an externally applied panel selection signal, and selecting one of the display panels to adjust the intensity of the light from the lamps and supplying the light to the display panel.

The lamp controlling unit may select a predetermined number of lamps and vary the intensity of the light by adjusting a magnitude of the signal applied to the rest of the lamps except the selected lamps.

The lamp controlling unit may select a predetermined number of lamps and adjust the intensity of the light from the lamps by lighting the selected lamps.

The display panels may include a first display panel and a second display panel, and the first display panel is larger than the second display panel.

The selected lamps may face an edge of the second display panel.

The lamps may be light emitting diodes (LEDs).

A display device including at least two display panels and a plurality of lamps disposed opposite each other with respect to one display panel is provided, which includes a lamp controlling unit selecting a predetermined number of lamps based on an externally applied panel selection signal and supplying the light to at least one side of each display panel by lighting the selected lamps.

The display panels may include a first display panel and a second display panel, and the first display panel is larger than the second display panel.

The lamp controlling unit may supply the light to both sides of the first display panel when the selected display based on the panel selection signal is the first display panel.

The lamp controlling unit may supply the light to one side of the second display panel when the selected display based on the panel selection signal is the second display panel.

The display panels may be display panels for liquid crystal displays.

The lamps may be light emitting diodes (LEDs).

A display device is provided, which includes: a first printed circuit board (PCB) including a plurality of lamps, a first lead and a plurality of other leads connected to the lamps; a flexible printed circuit (FPC) board including a first signal line connected to the first lead and a plurality of signal lines connected to second leads; a second PCB including a third lead connected to the first signal line and a plurality of fourth leads connected to the second signal lines; a lamp controlling unit applying a first voltage to the third lead, applying a second voltage to the fourth leads, and controlling the application of the second voltage based on an external panel selection signal; and first and second display panels supplied with light from the lamps, wherein the lamp controlling unit is mounted on the second PCB, the lamps are disposed opposite each other with respect to one display panel of the display panels and supply the light to the first and second display panels by lighting the lamps based on the difference between the first voltage and the second voltage, and some of the lamps supply the light of the first display panel only.

The first voltage may be larger than the second voltage.

The lamps may be light emitting diodes (LEDs).

The first voltage may be commonly transmitted to one terminal of each of the LEDs and the second voltage is separately transmitted to the other terminals of the LEDs, and the lamp controlling unit controls the application of the second voltage applied to the respective other terminals of the LEDs based on the panel selection signal.

A method of driving a display device including at least two display panels and a plurality of lamps disposed opposite each other with respect to one display panel and supplying light to the display panels is provided, which includes: reading an external panel selection signal; selecting one of the display panels based on the panel selection signal; selecting a predetermined number of lamps based on the selected panel; and supplying light to at least one side of each display panel by lighting the selected lamps.

The display panels may include a first display panel and a second display panel, and the first display panel is larger than the second display panel.

The selection of predetermined lamps may supply the light to both sides of the first display panel when the selected display panel based on the panel selection signal is the first display panel.

A display device including a first display panel, a second display panel, and a plurality of lamps disposed opposite each other with respect to one of the display panels and supplying light to the first and second display panel is provided, which includes: an openness sensing unit, in which an output signal is defined based on the degree of openness of the display device; a lamp controlling unit for selecting one of the display panels based on the output signal from the openness sensing unit, defining the number of lamps to be turned on based on the selected display panel, and supplying the light to at least one side of each of the first and second display panels by lighting the defined number of lamps.

The first display panel is larger than the second display panel, and the lamp controlling unit supplies the light to both sides of the first display panel when the selected display panel based on the panel selection signal is the first display panel.

The display device may be a display device for a mobile phone.

The lamps may be light emitting diodes.

A display device including at least two display panels and a plurality of lamps disposed opposite each other with respect to one of the display panels and supplying light to the first and second display panels is provided, which includes: a lamp controlling unit varying a signal applied to the lamps based on an externally applied panel selection signal and selecting one of the display panels to adjust the intensity of the light from the lamps and supplying the light to at least one side of each of the display panels.

The lamp controlling unit may select a predetermined number of lamps and vary the intensity of the light by adjusting a magnitude of the signal applied to the rest of the lamps except the selected lamps.

The lamp controlling unit may select a predetermined number of lamps and adjust the intensity of the light from the lamps by lighting the selected lamps.

The display panels may include a first display panel and a second display panel, and the first display panel is larger than the second display panel.

The selected lamps may be opposite each other with respect to the first display panel.

The lamps may be light emitting diodes.

### BRIEF DESCRIPTION OF THE DRAWINGS

The present invention will become more apparent by describing preferred embodiments thereof in detail with reference to the accompanying drawings, in which:

FIG. 1 is an exploded perspective view of a dual LCD according to an embodiment of the present invention;

FIG. 2 is a block diagram of an LCD mounted on a main display panel of the dual LCD shown in FIG. 1;

FIG. 3 is an equivalent circuit diagram of a pixel of the LCD shown in FIG. 2;

FIG. 4 is a schematic diagram illustrating the connection relation between signal lines formed on a printed circuit board (PCB) and a PCB for lamps, and signal lines formed on a flexible printed circuit (FPC) board for lamps, according to the embodiment of the present invention;

FIG. 5 is a circuit diagram of a lamp unit according to the embodiment of the present invention;

FIG. 6 is a diagram illustrating a position relation between light emitting diodes (LEDs), the main display panel, and a sub-display panel;

FIG. 7 is a flow chart of a lamp controller according to the embodiment of the present invention;

FIG. 8 is an exploded perspective view of a dual LCD according to another embodiment of the present invention;

FIG. 9 is a block diagram of an LCD mounted on a main display panel of the dual LCD shown in FIG. 8;

FIG. 10 is a schematic diagram illustrating the connection relation between signal lines formed on a PCB and a PCB for lamps, and signal lines formed on a flexible printed circuit (FPC) board for lamps, according to another embodiment of the present invention;

FIG. 11 is a circuit diagram of a lamp unit according to another embodiment of the present invention; and

FIG. 12 illustrates a lighting state of LEDs mounted on the main display panel and the sub-display panel according to another embodiment of the present invention.

### DETAILED DESCRIPTION OF EMBODIMENTS

The present invention will be described more fully hereinafter with reference to the accompanying drawings, in which preferred embodiments of the inventions invention are shown.

In the drawings, the thickness of layers and regions are exaggerated for clarity. Like numerals refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, there are no intervening elements present.

A display device, a driving method of the display device, and a driving device of a light source for the display device according to embodiments of the present invention will be described with reference to the accompanying drawings.

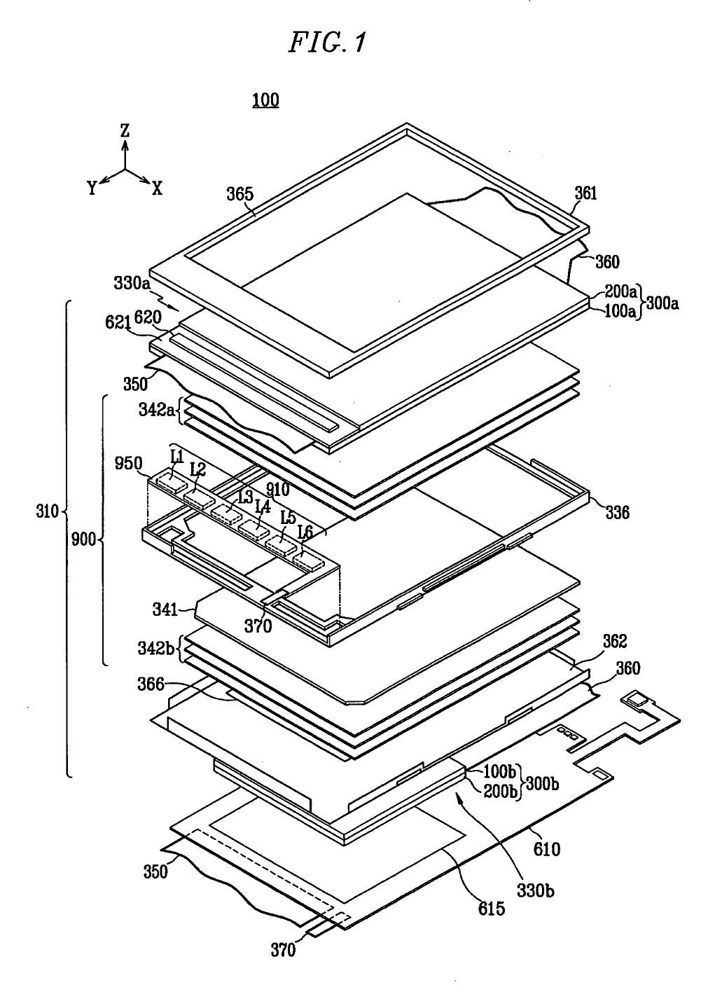

A liquid crystal display (LCD), in particular a dual LCD for a mobile phone having a main display window and a sub-display window according to an embodiment of the present invention will now be described in detail with reference to FIGS. 1 to FIG. 6.

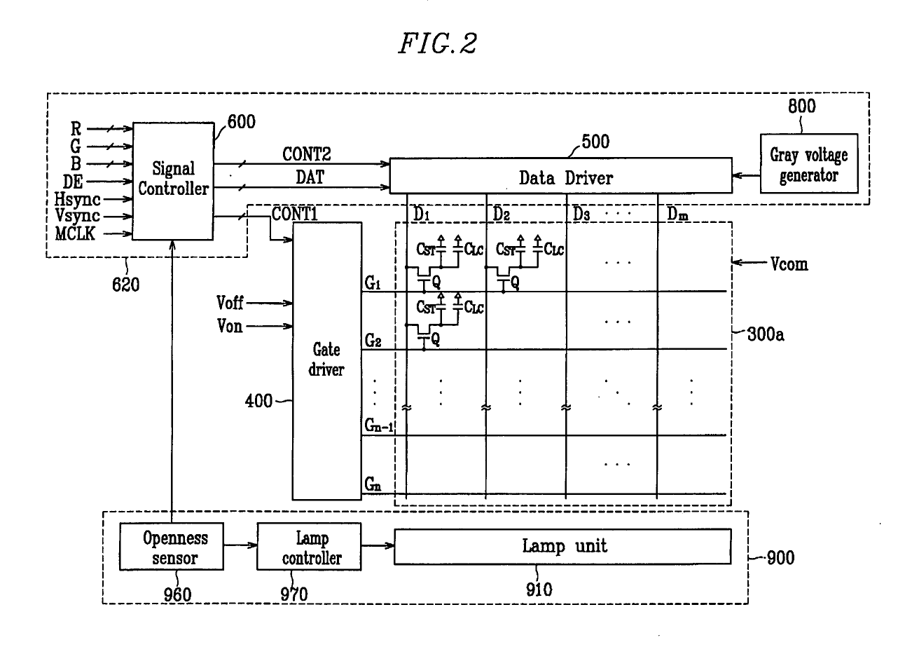

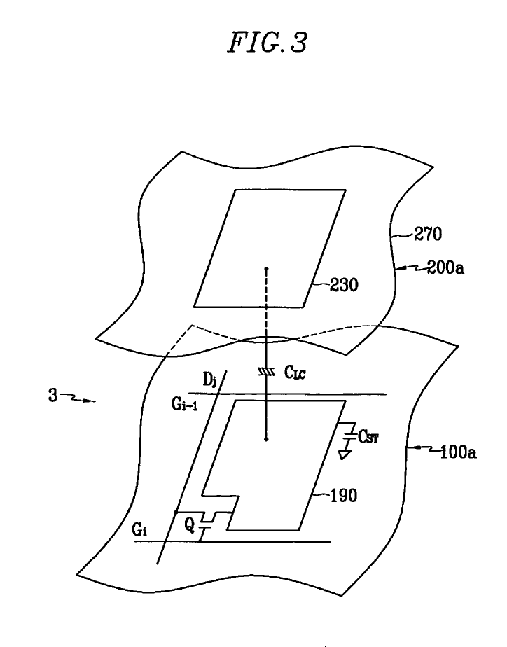

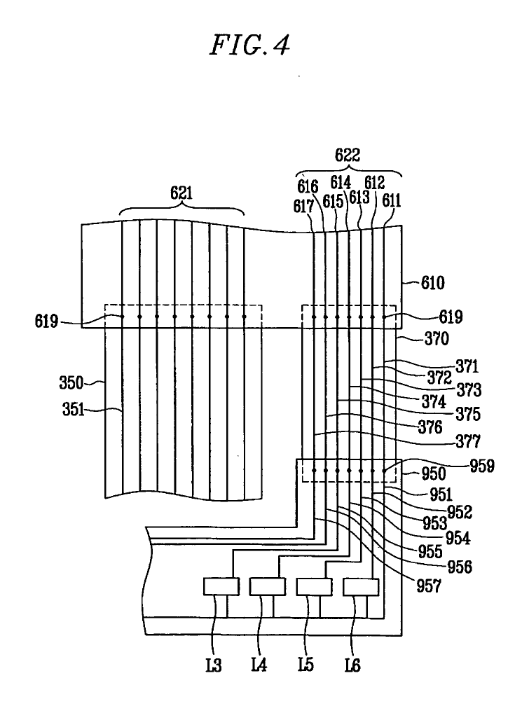

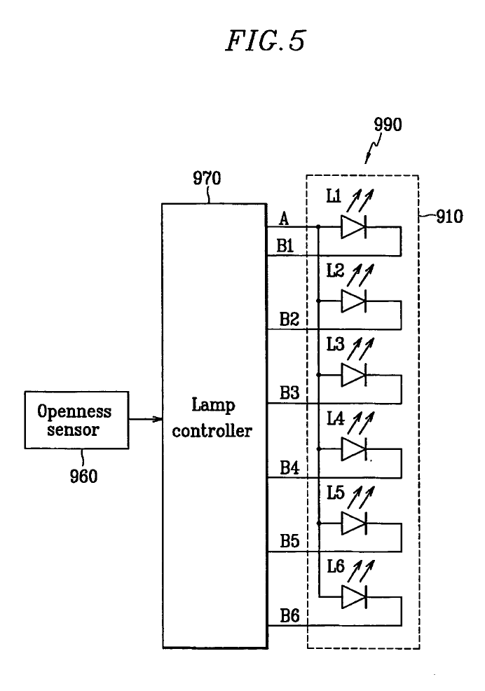

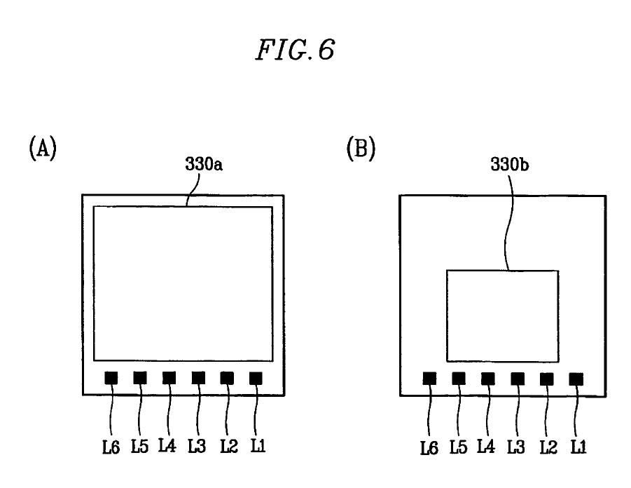

FIG. 1 is an exploded perspective view of a dual LCD according to an embodiment of the present invention, FIG. 2 is a block diagram of an LCD mounted on a main display panel of the dual LCD shown in FIG. 1, FIG. 3 is an equivalent circuit diagram of a pixel of the LCD shown in FIG. 2, FIG. 4 is a schematic diagram illustrating the connection relation between signal lines formed on a printed circuit board (PCB) and a PCB for lamps and signal lines formed on a flexible printed circuit (FPC) board for lamps according to the embodiment of the present invention, FIG. 5 is a circuit diagram of a lamp unit according to the embodiment of the present invention, and FIG. 6 is a diagram illustrating a position relation between light emitting diodes (LEDs) and the main display panel and a sub-display panel.

Referring to FIG. 1, the dual LCD according to the embodiment of the present invention includes an LC module 310 having a main display panel 330a, a sub-display panel 330b, and a backlight unit 900, a pair of front and rear chassis 361 and 362 containing the LC module 310, a mold frame 336, a plurality of flexible printed circuit (FPC) boards 350, 360, and 370, and a printed circuit board (PCB) 610.

The main display panel 330a includes a main LC panel assembly 300a, an integrated chip 620 mounted on the main LC panel assembly 300a, and a protection film 621 applied around the integrated chip 620.

The sub-display panel 330b includes a sub-LC panel assembly 300b.

The main display panel 330a is larger than the sub-display panel 330b.

The main LC panel assembly 300a and the sub-LC panel assembly 300b include lower panels 100a and 100b, upper panels 200a and 200b, and a LC layer 3 interposed therebetween, respectively, as shown in FIG. 3.

The construction of the main LC panel assembly 300a is to the same as that of the sub-LC panel assembly 300b and, for convenience of explanation, only the main LC panel assembly 300a will be described with reference to FIGS. 2 and 3.

The lower panel 100a includes a plurality of display signal lines G1-Gn and D1-Dm, and the lower and upper panels 100a and 200a include a plurality of pixels connected to the display signal lines G1-Gn and D1-Dm and arranged substantially in a matrix in circuital view as shown in FIGS. 2 and 3.

The display signal lines G1-Gn and D1-Dm include a plurality of gate lines G1-Gn transmitting gate signals (also referred to as “scanning signals”) and a plurality of data lines D1-Dm transmitting data signals. The gate lines G1-Gn extend substantially in a row direction and are substantially parallel to each other, while the data lines D1-Dm extend substantially in a column direction and are substantially parallel to each other.

Each pixel includes a switching element Q connected to the display signal lines G1-Gn and D1-Dm, and an LC capacitor C_{LC} and a storage capacitor C_{ST} that are connected to the switching element Q. The storage capacitor C_{ST} may be omitted in other embodiments.

The switching element Q that may be implemented as a TFT is disposed on the lower panel 100a. The switching element Q has three terminals: a control terminal connected to one of the gate lines G1-Gn; an input terminal connected to one of the data lines D1-Dm; and an output terminal connected to the LC capacitor C_{LC} and the storage capacitor C_{ST}.

The LC capacitor C_{LC} includes a pixel electrode 190 provided on the lower panel 100a and a common electrode 270 provided on an upper panel 200a as two terminals. The LC layer 3 disposed between the two electrodes 190 and 270 functions as a dielectric of the LC capacitor C_{LC}. The pixel electrode 190 is connected to the switching element Q, and the common electrode 270 is supplied with a common voltage Vcom and covers an entire surface of the upper panel 200a. In other embodiments, the common electrode 270 may be provided on the lower panel 100a, and both electrodes 190 and 270 may have shapes of bars or stripes.

The storage capacitor C_{ST} is an auxiliary capacitor for the LC capacitor C_{LC}. The storage capacitor C_{ST} includes the pixel electrode 190 and a separate signal line, which is provided on the lower panel 100a, overlaps the pixel electrode 190 via an insulator, and is supplied with a predetermined voltage such as the common voltage Vcom. Alternatively, the storage capacitor C_{ST} includes the pixel electrode 190 and an adjacent gate line called a previous gate line, which overlaps the pixel electrode 190 via an insulator.

For color display, each pixel uniquely represents one of primary colors (i.e., spatial division) or each pixel sequentially represents the primary colors in turn (i.e., temporal division) such that a spatial or temporal sum of the primary colors is recognized as a desired color. An example of a set of the primary colors includes red, green, and blue colors. FIG. 3 shows an example of the spatial division in which each pixel includes a color filter 230 representing one of the primary colors in an area of the upper panel 200a facing the pixel electrode 190. Alternatively, the color filter 230 is provided on or under the pixel electrode 190 on the lower panel 100a.

One or more polarizers (not shown) for polarizing the light are attached to the outer surfaces of the panels 100a and 200a.

The gate driver 400 is connected to the gate lines G1-Gn, and synthesizes the gate-on voltage Von and the gate-off voltage Voff from an external device to generate gate signals for application to the gate lines G1-Gn. The gate driver 400 is directly incorporated on the lower panel 100a of the main LC panel assembly 300a along with the switching device Q and display signal lines G1-Gn.

As shown in FIG. 1, the integrated chip 620 is directly mounted on the lower panel 100a of the main LC panel assembly 300a (referred to as COG (chip on glass)), and, as shown in FIG. 2, includes a signal controller 600, a data driver 500 connected to the signal controller 600, and a gray voltage generator 800 connected to the data driver 500.

The gray voltage generator 800 generates two sets of gray voltages related to the transmittance of the pixels. The gray voltages in one set have a positive polarity with respect to the common voltage Vcom, while those in the other set have a negative polarity with respect to the common voltage Vcom.

The data driver 500 includes a plurality of IC chips mounted on the respective data TCPs 510.

The data driver 500 is connected to the data lines D1-Dm of the main LC panel assembly 300a and applies data voltages selected from the gray voltages supplied from the gray voltage generator 800 to the data lines D1-Dm.

The signal controller 600 is connected to the backlight unit 900 and controls the drivers 400 and 500, etc.

As shown in FIGS. 1, 2, and 4 to 6, the backlight unit 900 is fixed near an edge of a short axis of the mold frame 336 and includes a lamp unit 910 emitting light toward the main LC panel assembly 300a and the sub-LC panel assembly 300b, an openness sensor 960 connected to the signal controller 600 of the integrated chip 620 and sensing a degree of openness of the mobile phone, a lamp controller 970 connected to the openness sensor 960 and the lamp unit 910, a PCB 950 on which the lamp unit 910 is mounted, a light guide plate 341 guiding the light from the lamp unit 910 toward the main LC panel assembly 300a and the sub-LC panel assembly 300b and uniformly maintaining the intensity of the light, and a plurality of optical sheets 342a and 342b disposed under and over the light guide plate 341 and guaranteeing luminance characteristics.

The lamp unit 910 includes a plurality of LEDs L1-L6. In the present embodiment, the number of LEDs mounted on the lamp unit 910 is six, but in other embodiments, the number of LEDS may be determined based on the operation of the LCD.

As shown in FIG. 6, on the PCB 950, the LEDs L1-L6 are disposed in the row direction along an edge of the main display panel 330a and are also disposed in the row direction and in left and right symmetry with respect to the center of an edge of the sub-display panel 330b.

The openness sensor 960 is preferably disposed on a connection portion (not shown) connected between a body of the mobile phone and the dual LCD and includes a sensing device, etc. outputting a voltage relative to resistance defined based on the degree of openness of the dual LCD from the body of the mobile phone. However, the arrangement position or the operation characteristics of the openness sensor may be changed in other embodiments.

The lamp controller 970 controls the lamp unit 910 based on the voltage from the openness senor 960 and may be incorporated on the PCB 610.

A plurality of FPC boards 350, 360, and 370 include a main FPC board 350 connected between the integrated chip 620 and the PCB 610, a sub-FPC board 360 connected between the main LC panel assembly 300a and the sub-LC panel assembly 300b, and an FPC board 370 connected between the PCB 950 and the PCB 610.

As shown in FIG. 4, a plurality of signal lines 351 and 371-377 are formed on the main FPC board 350 and the FPC 370.

The respective signal lines 351 are connected to a plurality of leads 621 formed on the PCB 610 through contacts 619. The signal lines 371-377 are connected to a plurality of leads 622 formed on the PCB 610 through the contacts 619 and connected to a plurality of leads 951-957 formed on the PCB 950 through contacts 959, respectively.

The signal lines 351 and 371-377 include signal lines 351 transmitting voltages for driving the integrated chip 620, control signals, and data, etc., and signal lines 371-377 transmitting driving signals to the corresponding LEDs L1-L6 of the lamp unit 910.

A plurality of leads and signal lines transmitting the control signals and the data may be further formed on the PCB 610, the FPC board 370, and the PCB 950, and the number of the leads and the signal lines may be varied depending on the application.

A plurality of signal lines may be formed on the sub-FPC board 360, and data or control signals from the main LC panel assembly 300a may be transmitted to the sub-LC panel assembly through the data or the control signals.

The front chassis 361 and rear chassis 362 include windows 365 and 366, respectively, and the PCP 610 also includes a window 615.

A display area of the main LC panel assembly 300a is exposed through the window 365.

The sub-LC panel assembly 300b receives the light from the lamp unit 910 through the window 366, and a display area of the sub-LC panel assembly 300b is exposed through the window 615.

A plurality of circuit components connected to the leads 621 and 622 are mounted on the PCB 610. Besides the leads 621 and 622, a plurality of leads (not shown) supplied with external signals is formed on the PCB 610. The front chassis 361 and the rear chassis 362 combine in upper and lower parts of the mold frame 363, respectively, and contain the LC module 310, to complete the dual LCD.

Now, the operation of the dual LCD will be described in detail.

Referring to FIG. 2, the signal controller 600 of the integrated chip 620 is supplied with input image signals R, G, and B, and input control signals controlling the display thereof such as a vertical synchronization signal Vsync, a horizontal synchronization signal Hsync, a main clock MCLK, and a data enable signal DE, from an external graphics controller (not shown) through the leads 621 of the PCB 610 and the signal lines 351 of the main FPC board 350. The signal controller 600 is also supplied with an openness sensing signal based on the degree of openness of the dual LCD from the openness sensor 960 of the backlight unit 900.

After selecting one of the main LC panel assembly 300a and the sub-LC panel assembly 300b depending on the openness sensing signal, generating gate control signals CONT1 and data control signals CONT2, and processing the image signals R, G, and B suitable for the operation of the selected panel assembly on the basis of the input control signals and the input image signals R, G, and B, the signal controller 600 provides the gate control signals CONT1 for the gate driver 400, and the processed image signals DAT and the data control signals CONT2 for the data driver 500.

Alternatively, the signal controller 600 may select one of the main LC panel assembly 300a and the sub-LC panel assembly 300b using separate circuit components or in another way.

The gate control signals CONT1 include a scanning start signal STV for instructing the gate driver 400 to start scanning and at least one clock signal for controlling the output time of the gate-on voltage Von. The gate control signals CONT1 may further include an output enable signal OE for defining the duration of the gate-on voltage Von.

The data control signals CONT2 include a horizontal synchronization start signal STH for informing of the start of data transmission for a group of pixels, a load signal LOAD for instructing the data driver 500 to apply the data voltages to the data lines D₁-Dₘ, and a data clock signal HCLK. The data control signal CONT2 may further include an inversion signal RVS for reversing the polarity of the data voltages (with respect to the common voltage Vcom).

In response to the data control signals CONT2 from the signal controller 600, the data driver 500 receives a packet of the image data DAT for the group of pixels from the signal controller 600, converts the image data DAT into analog data voltages selected from the gray voltages supplied from the gray voltage generator 800, and applies the data voltages to the data lines D₁-Dₘ of the main LC panel assembly 300a or the sub-LC panel assembly 300b.

The gate driver 400 of the selected main LC panel assembly 300a or sub-LC panel assembly 300b applies the gate-on voltage Von to the gate line G₁-Gₙ in response to the gate control signals CONT1 from the signal controller 600, thereby turning on the switching elements Q connected thereto. The data voltages applied to the data lines D₁-Dₘ are supplied to the pixels through the activated switching elements Q.

The main LC panel assembly 300a or sub-LC panel assembly 300b that is not selected may be supplied with data voltages for a black color from the signal controller 600 or a separate device through the data lines D₁-Dₘ.

The difference between the data voltage and the common voltage Vcom applied to a pixel is expressed as a charged voltage of the LC capacitor C_{LC} , i.e., a pixel voltage. The liquid crystal molecules have orientations depending on the magnitude of the pixel voltage.

The backlight unit 900 controls the lighting of the lamp unit 910 based on the openness sensing signal from the openness sensor 960. The operation of the backlight unit 900 will be described later.

The light from the lamp unit 910 passes through the LC layer 3 and varies its polarization according to the orientations of the liquid crystal molecules. The polarizers convert the light polarization into light transmittance.

By repeating this procedure by a unit of the horizontal period (which is denoted by “1H” and is equal to one period of the horizontal synchronization signal Hsync and the data enable signal DE), all gate lines G₁-Gₙ are sequentially supplied with the gate-on voltage Von during a frame, thereby applying the data voltages to all pixels. When the next frame starts after finishing one frame, the inversion control signal RVS applied to the data driver 500 is controlled such that the polarity of the data voltages is reversed (which is referred to as “frame inversion”). The inversion control signal RVS may also be controlled such that the polarity of the data voltages flowing in a data line in one frame is reversed (for example, line inversion and dot inversion), or the polarity of the data voltages in one packet are reversed (for example, column inversion and dot inversion).

Now, the operation of the backlight unit 900 according to the embodiment of the present invention will be described in detail with reference to FIGS. 2, and 4 to 7.

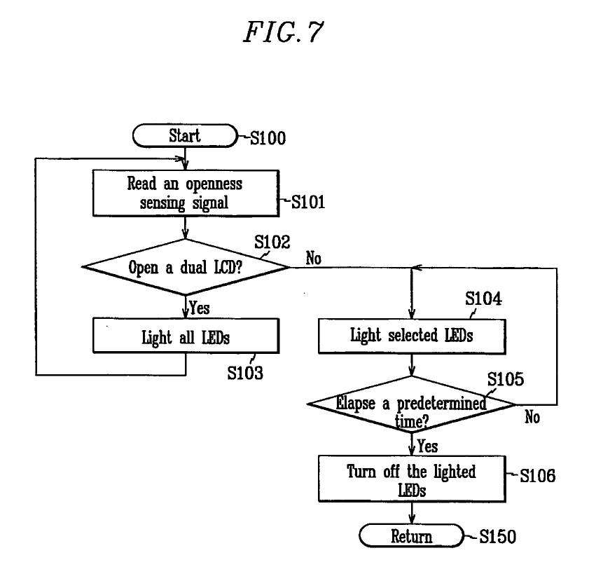

FIG. 7 is a flow chart of the lamp controller according to the embodiment of the present invention.

As stated above, the lamp unit 910 includes a plurality of LEDs L1-L6 of which (+) terminals are commonly connected to a common terminal A connected to the lamp controller 970, and (−) terminals are connected to corresponding output terminals B1-B6 separately connected to the lamp controller 970.

The operation of the backlight unit 900 will be described in detail below.

After applying a supply voltage to the backlight unit 900, the lamp controller 970 applies a voltage required for the operation of the LEDs L1-L6, for example about 3.3V, to the (+) terminal of the LEDs L1-L6. That is, the voltage transmitted through the leads 611 of the PCB 610 is transmitted to the signal lines 951 of the PCB 950 via the contacts 619 and the signal lines 371 of the FPC board 370, to be applied to the (+) terminals of all of the LEDs L1-L6.

However, since no voltage is applied to the output terminals B1-B6, a current does not flow through the LEDs L1-L6, and thereby the LEDs L1-L6 turn off.

Next, the lamp controller 970 reads the openness sensing signal from the openness sensor 960 (S101) and determines the degree of openness of the mobile phone (S102).

When a voltage of the openness sensing signal is larger than a predetermined voltage, the lamp controller 970 determines that the dual LCD is opened from the body of the mobile phone to a predetermined amount or more. Thus, the lamp controller 970 determines a state that the main display panel 330a is selected for displaying images.

Accordingly, the lamp controller 970 turns on all of the LEDs L1-L6 of the lamp unit 910. For turning on the LEDs L1-L6, the-lamp controller 970 applies grounds to the leads 952-957 of the PCB 950 through the leads 612-617 of the PCB 610 and the signal lines 372-377 of the FPC board 370, respectively.

Thus, the LEDs turn on (S103), and thereby the light is simultaneously transmitted to both the main LC panel assembly 300a and the sub-LC panel assembly 300b. At this time, the gate driver of the sub-display panel 330b does not transmit the gate-on voltages Von to the gate lines. Accordingly, although the data voltages for the main display panel 330a are applied to data lines of the sub-LC panel assembly 300b, images are not displayed on the sub-display panel 330b.

Next, the lamp controller 970 reads the openness sensing signal from the openness sensor 960 and determines whether or not the dual LCD of the mobile phone is closed (S101 and S102).

When the voltage of the openness sensing signal is smaller than the predetermined voltage, the lamp controller 970 determines that the dual LCD is closed to the body of the mobile phone. That is, the lamp controller 970 determines a state that the sub-display panel 330b is selected for display images.

Subsequently, the lamp controller 970 turns on a predetermined number of LEDs for a predetermined time, and turns off the remaining LEDs (S104 and S105). At this time, as shown in FIG. 6, the LEDs L2-L5 disposed near the edge of the sub-display panel 330b turn on and the rest of the LEDs L1 and L6 disposed apart from the edge turn off.

By the lighting of the LEDs L2-L5, the light is supplied to both the main LC panel assembly 300a and the sub-LC panel assembly 300b.

At this time, the gate driver 400 of the main display panel 330b does not transmit the gate-on voltages Von to the gate lines G1-Gn. Accordingly, although the data voltages for the sub-display panel 330b are applied to data lines D1-Dm of the main LC panel assembly 300a, images are not displayed on the main display panel 330a.

The number and disposition of the LEDs to be turned on or off may be varied in consideration of the size or shape of the sub-display panel 330b.

For lighting the LEDs L2-L5, the lamp controller 970 stops application of the voltage, i.e. the ground, applied to (−) terminals of the LEDs L1 and L6 connected to the signal lines 612 and 617 (S106), to shut off the ground applied to the output terminals B1 and B6.

At this time, the lamp controller 970 maintains application of the ground to the rest of the signal lines 613-616, and thereby the ground is continuously applied to the output terminals B2-B5.

As a result, when images are displayed only on the sub-display panel 330b that is smaller than the main display panel 330a, only the selected LEDs turn on instead of lighting all of the LEDs L1-L6 to change the intensity of the light emitted from lamp unit 910 based on the size of the selected display panel, and thereby the unnecessary consumption of power decreases.

Alternatively, some LEDs disposed correspondingly to the edge of the sub-display panel 330b may be supplied with a voltage larger than the voltage applied to the rest of the LEDs disposed apart from the edge, to change the intensity of the lamp unit 910. Moreover, when the sub-display panel 330b is selected, the intensity of the light unit 910 may be changed by decreasing voltages applied to the respective lamps such as the LEDs L1-L6.

According to the embodiment of the present invention, in the dual LCD including a plurality of display panels such as the main display panel and the sub-display panel, when images are displayed on the sub-display panel that is smaller than the main display panel, the intensity of the predetermined number of lamps is changed. Thus, when a certain quantity of the light is unnecessary, the power consumed by the lamps decreases to decrease the total power consumption of the dual LCD.

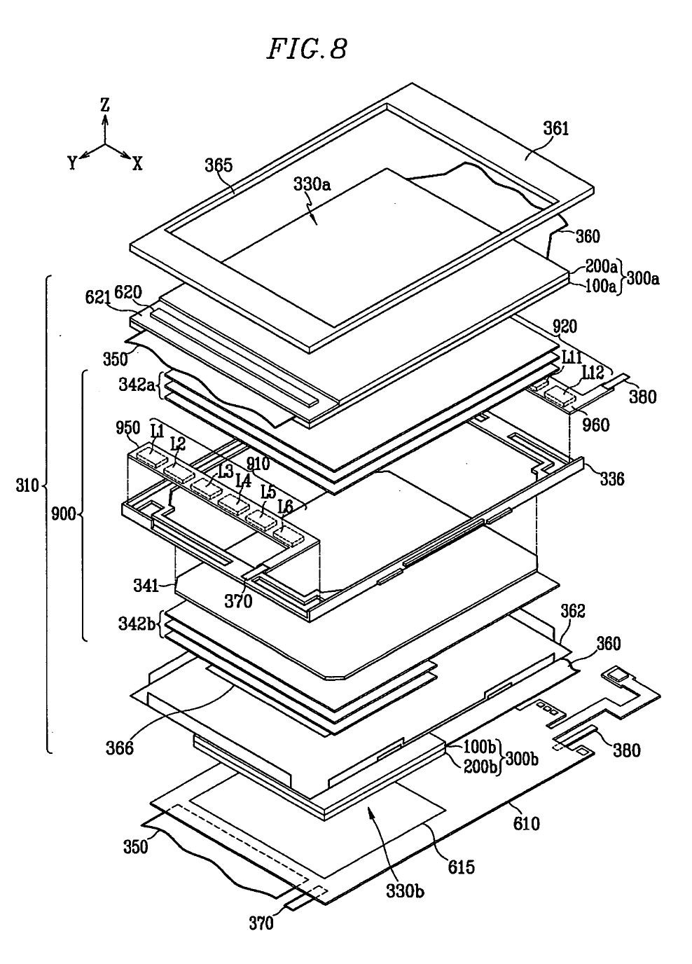

Next, another embodiment of the present invention will be described with reference to FIGS. 8 to 12. As compared with FIGS. 1 to 7, the elements performing the same operations are indicated with the same reference numerals, and a detailed description thereof is omitted.

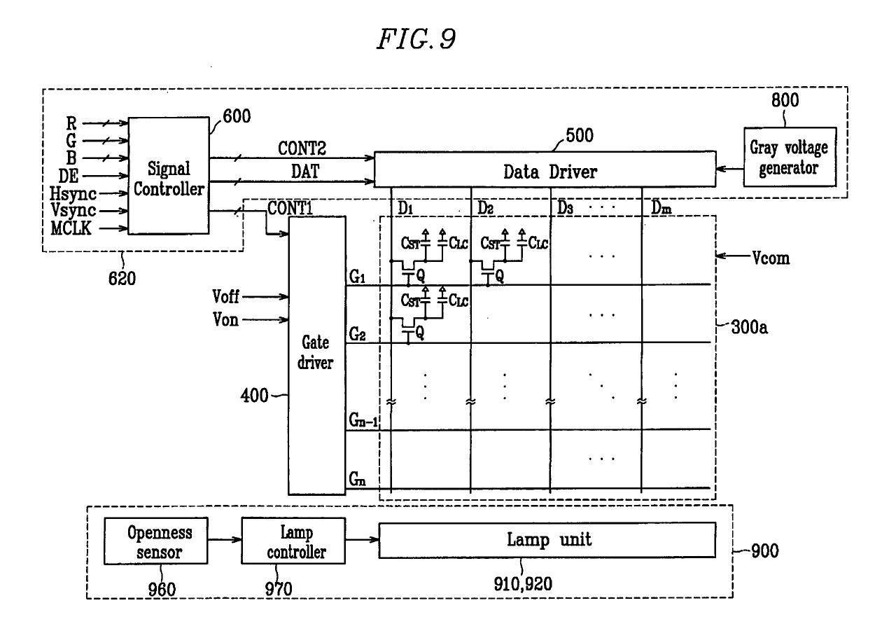

FIG. 8 is an exploded perspective view of a dual LCD according to another embodiment of the present invention, and FIG. 9 is a block diagram of an LCD mounted on a main display panel of the dual LCD shown in FIG. 8;

Different from the dual LCD according to the embodiment of the present invention with reference to FIGS. 1 to 7, a dual LCD according to this embodiment of the present invention includes a lamp unit 920 having a plurality of LEDs L7-L12 as well as a lamp unit 910 having LEDs L1-L6. Thus, the dual LCD according to this embodiment of the present invention also includes a PCB 960 on which the lamp unit 920 is mounted, in addition to a PCB 950 mounted with the lamp unit 910.

As shown in FIG. 8, the PCB 950 is located near an edge of the mold frame 336, that is, near one edge of the short axis thereof, and the PCB 960 is located near an opposition position to the PCB 950, that is, near another edge of the short axis of the mold frame 336.

Besides FPC boards 350, 360, and 370, the dual LCD also includes a FPC board 380 transmitting signals or data between the lamp unit 920 and a PCB 610.

As shown in FIG. 8, the display areas of the main LC assembly 300a and the sub-LC assembly 300b are exposed through the windows 365 and 366 of the front and rear chassis 361 and 362, respectively. The main LC panel assembly 300a displays images by receiving light from the lamp units 910 and 920, and the sub-LC panel assembly 300b displays images by receiving the light from the lamp unit 910.

Referring to FIG. 8, the lamp units 910 and 920 are fixed on both ends of the mold frame 336 along a Y-axis, and they supply the light to at least one side of the main LC assembly 300a and the sub-LC assembly 300b, respectively.

Except for the structural features described above, the structure of the dual LCD shown in FIGS. 8 and 9 is substantially the same as that of the dual LCD shown in FIGS. 1 and 2, and a detailed description thereof is omitted.

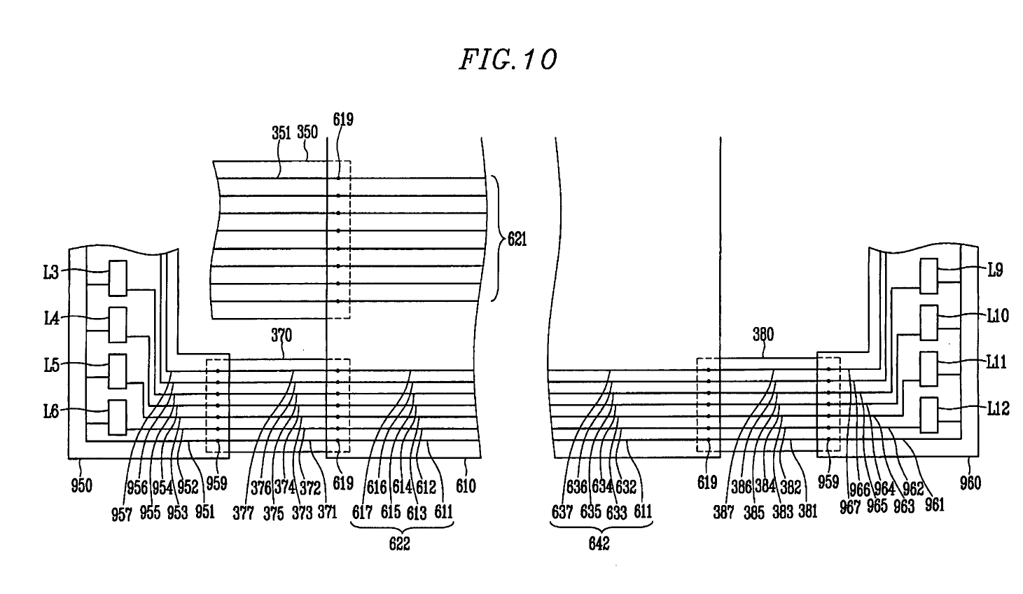

Next, referring to FIG. 10, signal lines formed on the PCB 610 and the PCBs 950 and 960 for lamp units 910 and 920 and the relation between the signals will be described in detail.

FIG. 10 is a schematic diagram illustrating the connection relation between signal lines formed on a PCB and a PCB for lamps, and signal lines formed on a flexible printed circuit (FPC) board for lamps according to another embodiment of the present invention.

Referring to FIG. 10, a plurality of signal lines 351, 371-377, and 381-387 are formed on the main FPC board 350, the FPC boards 370 and 380 for lamp units 910 and 920.

The signal lines 351 shown on the left upper portion of FIG. 10 are connected to a plurality of leads 621 formed on the PCB 610 through contacts 619 and connected to a plurality of leads 951-957 formed on the PCB 950 through contacts 959.

Likewise, the signal lines 381-387 formed on the PFC board 380 and shown on the right portion of FIG. 10 are connected to a plurality of leads 642 formed on the PCB 610 through contacts 619 and connected to a plurality of leads 951 and 962-967 formed on the PCB 950 through contacts 959.

The signal lines 351, 371-377, and 381-387 include the signal lines 351 for transmitting voltages, control signals, and data, etc., required for the operation of an integrated chip 620 and signal lines 371-377 and 381-387 transmitting driving signals to the respective LEDs L1-L12 of the lamp units 910 and 920. A plurality of signal lines and leads transmitting control signals and data etc. may be further formed on the PCB 610, the FPC boards 370 and 380, and the PCBs 950 and 960, and the number of the signal lines and leads are determined in consideration of the operation of the dual LCD. A plurality of circuit components connected to the leads 621, 622, and 642 are mounted on the PCB 610. Besides the leads 621, 622, and 642, a plurality of signal lines (not shown) receiving control signals etc. is also formed on the PCB 610. Although not shown, a plurality of signal lines, through which data or control signals are transmitted from the main LC panel assembly 300a to the sub-LC panel assembly 300b, are formed on the sub-FPC board 360.

Since the operation of the dual LCD according to the present embodiment of the present invention is to the same as the operation of the dual LCD described referring to FIGS. 1 to 3, the operation of the dual LCD according to the present embodiment of the present invention is omitted.

However, the operations of the lamp units 910 and 920 according to the embodiment of the present invention will be described in detail with reference to FIGS. 10 to 12.

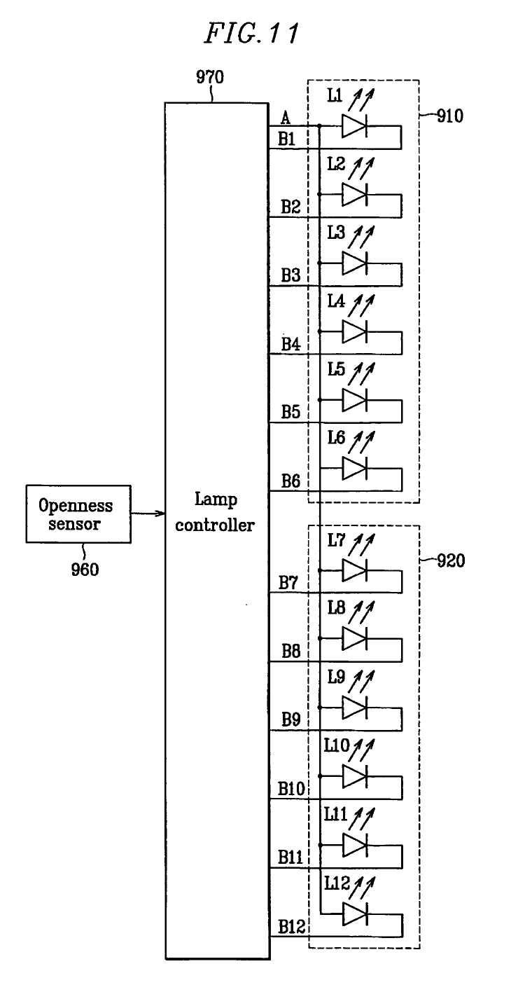

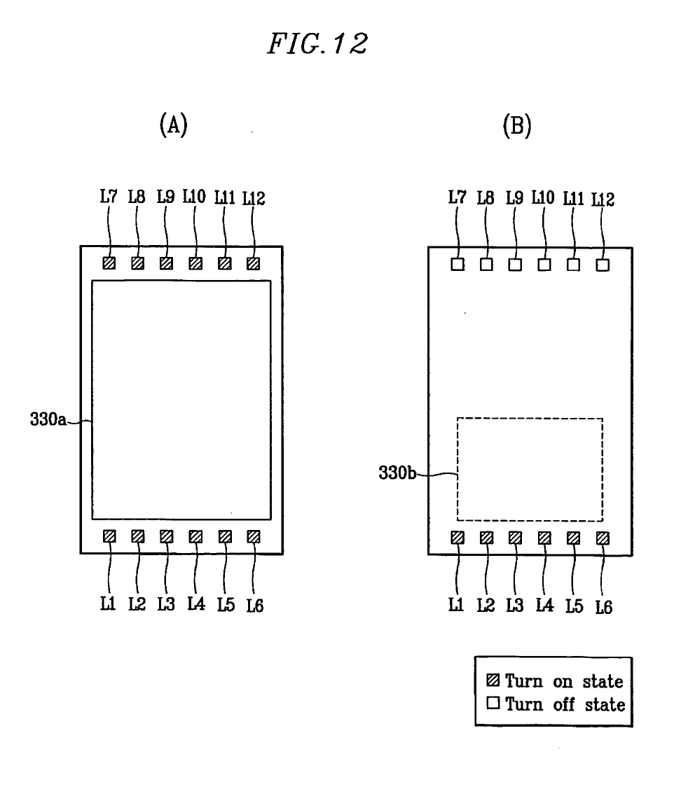

FIG. 11 is a circuit diagram of a lamp unit according to the embodiment of the present invention, and FIG. 12 illustrates a lighting state of LEDs mounted on the main display panel and the sub-display panel according to the embodiment of the present invention.

As described above, the lamp units 910 and 920 include a plurality of LEDs L1-L6 and L7-L12, respectively. (+) terminals of the respective LEDs L1-L6 and L7-L12 are commonly connected to a common terminal A connected to the lamp controller 970, and the respective (−) terminals are connected to corresponding output terminals B1-B12 separately connected to the lamp controller 970.

The operation of the lamp controller 970 for turning the lamp units 910 and 920 on or off is substantially the same as that of the operation of the flow chart shown in FIG. 7.

That is, after the operation of the lamp controller 970 is started (S100) by applying a supply voltage to the inverter 900, the lamp controller 970 applies a voltage required for the operation of the LEDs L1-L12, for example about 3.3V, to the (+) terminal of the LEDs L1-L12.

Accordingly, as shown in FIG. 10, the voltage transmitted through the leads 611 of the PCB 610 is transmitted to the signal lines 951 of the PCBs 950 and 960 via the contacts 619 and the signal lines 371 and 381 of the FPC boards 370 and 380, to be applied to the (+) terminals of all of the LEDs L1-L12. However, since no voltage is applied to the output terminals B1-B12, a current does not flow through the LEDs L1-L12, and thereby the LEDs L1-L12 turn off.

Next, the lamp controller 970 reads the openness sensing signal from the openness sensor 960 (S101) and determines the degree of openness of the mobile phone (S102).

When a voltage of the openness sensing signal is larger than a predetermined voltage, the lamp controller 970 determines that the dual LCD is opened from the body of the mobile phone by a predetermined amount or more. Thus, the lamp controller 970 determines a state that the main display panel 330a is selected for display images.

Accordingly, the lamp controller 970 turns on all of the LEDs L1-L12 of the lamp units 910 and 920. For turning on the LEDs L1-L12, the lamp controller 970 applies grounds to the leads 952-957 and 962-967 of the PCBs 950 and 960 through the leads 612-617 and 632-637 of the PCB 610 and the signal lines 372-377 and 382-387 of the FPC boards 370 and 380, respectively.

Thus, the LEDs L1-L12 turn on (S103), and thereby light is simultaneously transmitted to both the main LC panel assembly 300a and the sub-LC panel assembly 300b. At this time, the gate driver of the sub-display panel 330b does not transmit the gate-on voltages Von to gate lines of the sub-LC panel assembly 300b. Accordingly, although the data voltages for the main display panel 330a are applied to data lines of the sub-LC panel assembly 300b, images are not displayed on the sub-display panel 330b.

Next, the lamp controller 970 reads the openness sensing signal from the openness sensor 960 and determines whether or not the dual LCD of the mobile phone is opened (S101 and S102).

When the voltage of the openness sensing signal is smaller than the predetermined voltage, the lamp controller 970 determines that the dual LCD is closed to the body of the mobile phone. That is, the lamp controller 970 determines a state that the sub-display panel 330b is selected for display images.

Subsequently, the lamp controller 970 turns on the predetermined number of LEDs for a predetermined time and turns off the rest of the LEDs (S104 and S105). For example, the LEDs L1-L6 of the lamp unit 910 disposed on one side of the sub-display panel 330b are turned on.

At this time, the gate driver 400 of the main display panel 330a does not transmit the gate-on voltages Von to the gate lines G1-Gn of the LC panel assembly 300a. Accordingly, although the data voltages for the sub-LC panel assembly 300b are applied to the data lines D1-Dm of the main LC panel assembly 300a, images are not displayed on the main display panel 330a.

In this case, the lamp controller 970 stops application of the voltage, i.e. the ground, applied to (−) terminals of the LEDs L7-L12 connected to the signal lines 632-637 (S106), to shut off the ground applied to the output terminals B7-B12. At this time, the lamp controller 970 maintains application of the ground to the rest of the signal lines 612-617, and thereby the ground is continuously applied to the output terminals B1-B6.

As a result, when images are displayed only on the sub-display panel 330b that is smaller than the main display panel 330a, only the selected LEDs turn on instead of lighting all of the LEDs, and thereby the unnecessary consumption of power decreases.

As stated above, after dividing the LEDs L1-L12 into two lamp units 910 and 920, when the main display panel 330a is selected for display images, the lamp controller 970 turns on all of the lamp units 910 and 920, and when the sub-display panel 330b is selected for display images, the lamp controller 970 turns on only one of the lamp units 910 and 920. Each of the lamp units 910 and 920 may be simultaneously turned on or off.

According to the embodiment of the present invention, in the dual LCD including a plurality of display panels such as the main display panel and the sub-display panel and a plurality of lamp units, when images are displayed through the sub-display panel that is smaller than the main display panel, only one lamp unit turns on. Thus, the number of turned on lamps decreases, and thereby power consumption also decreases.

In the embodiments of the present invention, the lamp units include LEDs, but may include fluorescent lamps such as CCFLs (cold cathode fluorescent lamps) or EEFLs (external electrode fluorescent lamps). Also, the number of LEDs may be varied in consideration of the operation of the dual LCD.

While the present invention has been described in detail with reference to the preferred embodiments, it is to be understood that the invention is not limited to the disclosed embodiments, but, on the contrary, is intended to cover various modifications and equivalent arrangements included within the sprit and scope of the appended claims.

What is claimed is:

1. A display device comprising:
at least two display panels;
a plurality of lamps emitting light to the display panels; and
a lamp controlling unit selecting a predetermined number of the lamps based on an externally applied panel selection-signal and selecting one of the display panels and supplying the light to the display panel by lighting the selected lamps.

2. The device of claim 1, wherein the display panels include a first display panel and a second display panel, and the first display panel is larger than the second display panel.

3. The device of claim 2, wherein the selected lamps face an edge of the second display panel.

4. The device of claim 2, wherein the number of lamps selected when the selected display panel is the second display panel is less than the number of lamps selected when the selected display panel is the first display panel.

5. The device of claim 1, wherein the display device is a liquid crystal display.

6. The device of claim 5, wherein the lamps are light emitting diodes (LEDs).

7. A display device comprising:
a first printed circuit board (PCB) including a plurality of lamps, a first lead connected to the lamps, and a plurality of second leads connected to the lamps;
a flexible printed circuit (FPC) board including a first signal line connected to the first lead and a plurality of signal lines connected to the second leads, respectively;
a second PCB including a third lead connected to the first signal line and a plurality of fourth leads connected to the second signal lines;
a lamp controlling unit applying a first voltage to the third lead, applying a second voltage to the fourth leads, and controlling the application of the second voltage based on an external panel selection signal; and
a first and second display panels simultaneously supplied with light from the lamps,
wherein the lamp controlling unit is mounted on the second PCB and the lamps supply the light to the first and second display panels by lighting the lamps based on a difference between the first voltage and the second voltage.

8. The device of claim 7, wherein the first voltage is larger than the second voltage.

9. The device of claim 7, wherein the lamps are light emitting diodes (LEDs).

10. The device of claim 9, wherein the first voltage is commonly transmitted to one terminal of each of the LEDs and the second voltage is separately transmitted to the other terminals of the LEDs, and
the lamp controlling unit controls the application of the second voltage applied to the respective other terminals of the LEDs based on the panel selection signal.

11. A method of driving a display device including at least two display panels and a plurality of lamps supplying light to the display panels, the method comprising:
reading an external panel selection signal;
selecting one of the display panels based on the panel selection signal;
selecting a predetermined number of lamps based on the selected panel; and
supplying light to the display panels by lighting the selected lamps.

12. The method of claim 11, wherein the display panels include a first display panel and a second display panel, and the first display panel is larger than the second display panel.

13. The method of claim 12, wherein in the selection of the predetermined number of lamps, the number of lamps selected when the selected display panel is the second display panel is less than the number of lamps selected when the selected display panel is the first display panel.

14. A display device including a first display panel, a second display panel, and a plurality of lamps simultaneously supplying light to the first and second display panels, the device comprising:
an openness sensing unit, in which an output signal is defined based on a degree of openness of the display device;
a lamp controlling unit selecting one of the display panels based on the output signal from the openness sensing unit, defining a number of lamps to be turned on based on the selected display panel, and supplying the light to the first and second display panels by lighting the defined number of lamps.

15. The device of claim 14, wherein the first display panel is larger than the second display panel, and the number of lamps selected when the selected display panel is the second display panel is less than the number of lamps selected when the selected display panel is the first display panel.

16. The device of claim 15, wherein the display device is a display device for a mobile phone.

17. The device of claim 14, wherein the lamps are light emitting diodes.

18. A display device comprising:
at least two display panels;
a plurality of lamps supplying light to the display panels; and
a lamp controlling unit varying a signal applied to the lamps based on an externally applied panel selection signal and selecting one of the display panels to adjust the intensity of the light from the lamps and supplying the light to the display panel.

19. The device of claim 18, wherein the lamp controlling unit selects a predetermined number of lamps and varies the intensity of the light by adjusting a magnitude of the signal applied to the rest of the lamps except the selected lamps.

20. The device of claim 18, wherein the lamp controlling unit selects a predetermined number of lamps and adjusts the intensity of the light from the lamps by lighting the selected lamps.

21. The device of claim 19, wherein the display panels include a first display panel and a second display panel, and the first display panel is larger than the second display panel.

22. The device of claim 21, wherein the selected lamps face an edge of the second display panel.

23. The device of claim 21, wherein the lamps are light emitting diodes (LEDs).

24. A display device including at least two display panels and a plurality of lamps disposed opposite each other with respect to one display panel of the display panels, the device comprising:
a lamp controlling unit selecting a predetermined number of lamps based on an externally applied panel selection signal and supplying the light to at least one side of each display panel by lighting the selected lamps.

25. The device of claim 24, wherein the display panels include a first display panel and a second display panel, and the first display panel is larger than the second display panel.

26. The device of claim 25, wherein the lamp controlling unit supplies light to both sides of the first display panel when the selected display based on the panel selection signal is the first display panel.

27. The device of claim 25, wherein the lamp controlling unit supplies light to one side of the second display panel when the selected display based on the panel selection signal is the second display panel.

28. The device of claim 24, wherein the display panels are display panels for liquid crystal displays.

29. The device of claim 24, wherein the lamps are light emitting diodes (LEDs).

30. A display device comprising:
a first printed circuit board (PCB) including a plurality of lamps, and a first lead and a plurality of second leads connected to the lamps;
a flexible printed circuit (FPC) board including a first signal line connected to the first lead and a plurality of signal lines connected to the second leads;
a second PCB including a third lead connected to the first signal line and a plurality of fourth leads connected to the second signal lines;
a lamp controlling unit applying a first voltage to the third lead, applying a second voltage to the fourth leads, and controlling the application of a second voltage based on an external panel selection signal; and
first and second display panels supplied with light from the lamps,
wherein the lamp controlling unit is mounted on the second PCB,
the lamps are disposed opposite each other with respect to one of the display panels and supply the light to the first and second display panels by lighting the lamps based on a difference between the first voltage and the second voltage, and
some of the lamps supply the light of only the first display panel.

31. The device of claim 30, wherein the first voltage is larger than the second voltage.

32. The device of claim 30, wherein the lamps are light emitting diodes (LEDs).

33. The device of claim 32, wherein the first voltage is commonly transmitted to one terminal of each of the LEDs and the second voltage is separately transmitted to the other terminals of the LEDs, and the lamp controlling unit controls the application of the second voltage applied to the respective other terminals of the LEDs based on the panel selection signal.

34. A method of driving a display device including at least two display panels and a plurality of lamps disposed opposite each other with respect to one of the display panels and supplying light to the display panels, the device comprising:
reading an external panel selection signal;
selecting one of the display panels based on the panel selection signal;
selecting a predetermined number of lamps based on the selected panel; and
supplying light to at least one side of each display panel by lighting the selected lamps.

35. The device of claim 34, wherein the display panels include a first display panel and a second display panel, and the first display panel is larger than the second display panel.

36. The device of claim 35, wherein the selection of the predetermined lamps supplies the light to both sides of the first display panel when the selected display based on the panel selection signal is the first display panel.

37. A display device including a first display panel, a second display panel, and a plurality of lamps disposed opposite each other with respect to one of the display panels and supplying light to the first and second display panels, the device comprising:
an openness sensing unit, in which an output signal is defined based on a degree of openness of the display device; and
a lamp controlling unit selecting one of the display panels based on the output signal from the openness sensing unit, defining the number of lamps to be turned on based on the selected display panel, and supplying the light to at least one side of each of the first and second display panels by lighting the defined number of lamps.

38. The device of claim 37, wherein the first display panel is larger than the second display panels, and the lamp controlling unit supplies the light to both sides of the first display panel when the selected display based on the panel selection signal is the first display panel.

39. The device of claim 38, wherein the display device is a display device for a mobile phone.

40. The device of claim 37, wherein the lamps are light emitting diodes.

41. A display device including at least two display panels and a plurality of lamps disposed opposite each other with respect to one of the display panels and supplying light to the first and second display panel, the device comprising:
a lamp controlling unit varying a signal applied to the lamps based on an externally applied panel selection signal and selecting one of the display panels to adjust the intensity of the light from the lamps, and supplying the light to at least one side of each of the display panels.

42. The device of claim 41, wherein the lamp controlling unit selects a predetermined number of lamps and varies the intensity of the light by adjusting a magnitude of the signal applied to the rest of the lamps except the selected lamps.

43. The device of claim 41, wherein the lamp controlling unit selects a predetermined number of lamps and adjusts the intensity of the light from the lamps by lighting the selected lamps.

44. The device of claim 43, wherein the display panels include a first display panel and a second display panel, and the first display panel is larger than the second display panel.

45. The device of claim 44, wherein the selected lamps are opposite each other with respect to the first display panel.

46. The device of claim 44, wherein the lamps are light emitting diodes.
